(19) United States
(12) Patent Application Publication
(10) Pub. No.: US 2012/0026882 A1
(43) Pub. Date: Feb. 2, 2012

(54) APPARATUS AND METHOD FOR SUPPORTING AGPS TRAFFIC CLASS IN MOBILE COMMUNICATION SYSTEM

(75) Inventors: Jung-Shin PARK, Seoul (KR); Ji-Cheol LEE, Suwon-si (KR); Dong-Keon KONG, Suwon-si (KR); Nae-Hyun LIM, Seoul (KR)

(73) Assignee: SAMSUNG ELECTRONICS CO. LTD., Suwon-si (KR)

(21) Appl. No.: 13/195,212

(22) Filed: Aug. 1, 2011

(30) Foreign Application Priority Data
Jul. 30, 2010 (KR) 10-2010-0074152

(51) Int. Cl. H04W 28/24

(52) U.S. Cl. 370/235

(57) ABSTRACT

An apparatus and a method of a mobile communication system is provided. In a method for changing a Quality of Service (QoS) of a base station in a mobile communication system, when a QoS parameter change is detected from a packet received from a terminal, the changed QoS parameter is determined. A Generic Route Encapsulation (GRE) packet to which the changed QoS parameter has been applied is transmitted to an upper node. When a Dynamic Service Change (DSC) performance with the terminal is requested by the upper node, the DSC is performed with the terminal. The changed QoS parameter is applied.

### PRIORITY

This application claims the benefit under 35 U.S.C. §119(a) of a Korean patent application filed in the Korean Intellectual Property Office on Jul. 30, 2010 and assigned Serial No. 10-2010-0074152, the entire disclosure of which is hereby incorporated by reference.

### BACKGROUND OF THE INVENTION

1. Field of the Invention

The present invention relates to an apparatus and method for controlling traffic transmission in a communication system. More particularly, the present invention relates to an apparatus and a method for transmitting traffic of an adaptive Grant and Polling Service (aGPS) service class in a mobile communication system.

2. Description of the Related Art

A communication system implementing the Institute of Electrical and Electronics Engineers (IEEE) 802.16m standard now supports an aGPS scheduling service as a new Quality of Service (QoS) service class.

However, in an initial connection setting process of an aGPS service class defined in the IEEE 802.16m standard, negotiating a plurality of QoS parameter sets to be used by a terminal and a network, and then converting and using a QoS parameter set without transmitting a separate control signal when needed cannot be supported by the processing method of the related art.

Therefore, a need exists for an apparatus and method for supporting the aGPS traffic class in a mobile communication system.

### SUMMARY OF THE INVENTION

Aspects of the present invention are to address at least the above-mentioned problems and/or disadvantages and to provide at least the advantages described below. Accordingly, an aspect of the present invention is to provide an apparatus and a method for supporting an adaptive Grant and Polling Service (aGPS) traffic class in a mobile communication system.

Another aspect of the present invention is to provide an apparatus and a method for providing a new Quality of Service (QoS) service by defining an efficient network structure and a signal scheme for supporting an aGPS service class in a Worldwide Interoperability for Microwave Access (WiMAX) network system that supports the Institute of Electrical and Electronics Engineers (IEEE) 802.16m standard.

In accordance with an aspect of the present invention, a method for changing a QoS of a terminal in a mobile communication system is provided. The method includes, when it is determined to change the QoS, transmitting a packet where a QoS parameter has been changed to a base station, and when a Dynamic Service Change (DSC) performance request is not received from the base station, using the changed QoS parameter.

In accordance with another aspect of the present invention, a method for changing a QoS of a base station in a mobile communication system is provided. The method includes, when detecting a QoS parameter change from a packet received from a terminal, determining the changed QoS parameter, transmitting a Generic Route Encapsulation (GRE) packet to which the changed QoS parameter has been applied to an upper node, when performance of a DSC with the terminal is requested by the upper node, performing the DSC with the terminal, and applying the changed QoS parameter.

In accordance with still another aspect of the present invention, a method for changing a QoS of a network apparatus in a mobile communication system is provided. The method includes determining whether a GRE packet where a QoS parameter has been changed is received from a base station, when receiving the GRE packet where the QoS parameter has been changed, determining whether to allow a QoS parameter change based on a user QoS policy, and when not allowing the QoS parameter change, requesting the base station to perform DSC.

In accordance with yet another aspect of the present invention, an apparatus of a terminal, for changing a QoS in a mobile communication system is provided. The apparatus includes a QoS manager for, when it is determined to change a QoS, determining to transmit a packet where a QoS parameter has been changed to a base station, and for, when a DSC performance request is not received from the base station, using the changed QoS parameter, and a modem for transmitting a packet where the QoS parameter has been changed to the base station, and for receiving the DSC performance request from the base station.

In accordance with another aspect of the present invention, an apparatus of a base station, for changing a QoS in a mobile communication system is provided. The apparatus includes a wireless modem for communicating with a terminal, a wired modem for communicating with an upper node, a QoS manager for, when detecting a QoS parameter change from a packet received from the terminal via the wireless modem, determining the changed QoS parameter, for transmitting a GRE packet to which the changed QoS parameter has been applied to the upper node via the wired modem, and for applying the changed QoS parameter, and a DSC processor for, when performance of a DSC with the terminal is requested by the upper node, determining to perform the DSC with the terminal.

In accordance with still another aspect of the present invention, a network apparatus for changing a QoS in a mobile communication system is provided. The apparatus includes a modem for communicating with a base station, and a QoS manager for determining whether a GRE packet where a QoS parameter has been changed is received from the base station via the modem, and for, when receiving the GRE packet where the QoS parameter has been changed, determining whether to allow a QoS parameter change based on a user QoS policy, and a DSC processor for, when not allowing the QoS parameter change, requesting the base station to perform DSC.

In accordance with still another aspect of the present invention, a system for changing a QoS in a mobile communication system is provided. The system includes a terminal for, when it is determined to change the QoS, transmitting a packet where the QoS parameter has been changed to a base station, and for, when a DSC performance request is not received from the base station, using the changed QoS parameter, the base station for, when detecting a QoS parameter change from a packet received from the terminal, determining the changed QoS parameter, for transmitting a GRE packet to which the changed QoS parameter has been applied to a network apparatus, and for, when performance of a DSC with the terminal is requested by the network apparatus, performing the DSC with the terminal to apply the changed QoS parameter, and the network apparatus for determining whether a GRE packet where the QoS parameter has been changed is received from the base station, for, when receiving the GRE packet where the QoS parameter has been changed, determining whether to allow the QoS parameter change based on a user QoS policy, and for, when not allowing the QoS parameter change, requesting the base station to perform the DSC.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a view illustrating a control signal message flow for controlling a data path for transmitting traffic of an adaptive Grant and Polling Service (aGPS) service class according to an exemplary embodiment of the present invention;

FIG. 2 is a flowchart illustrating a process for operating a terminal according to an exemplary embodiment of the present invention;

FIG. 3 is a flowchart illustrating a process for operating a base station according to an exemplary embodiment of the present invention;

FIG. 4 is a flowchart illustrating a process for operating an Access Service Network Gateway (ASN GW) or a Policy Charging Resource Function (PCRF) according to an exemplary embodiment of the present invention;

FIG. 5 is a block diagram illustrating a terminal or a base station according to an exemplary embodiment of the present invention; and

FIG. 6 is a block diagram illustrating an ASN GW or a PCRF according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide an apparatus and a method for supporting an adaptive Grant and Polling Service (aGPS) traffic class in a mobile communication system.

A system that uses an Institute of Electrical and Electronics Engineers (IEEE) 802.16m standard manages Quality of Service (QoS) of a service provided to a terminal via an Access Service Network Gateway (ASN GW) and Authentication, Authorization and Accounting (AAA), or Policy Charging Resource Function (PCRF) in a QoS and Policy and Charging Control (PCC) structure.

For a terminal and a base station to automatically change and use a parameter when needed without transmitting a separate control signal after determining primary/secondary QoS parameters in advance during an initial setting of a relevant connection in an aGPS scheduling service, the following process is provided.

Exemplary embodiments of the present invention describe a role of each element of a network for providing an aGPS service and signal operations thereof.

First, an exemplary initial network entry procedure is described below. According to a method proposed by an exemplary embodiment of the present invention, during an initial network entry procedure of a terminal or during a process where a terminal generates a new aGPS connection, an ASN GW or a PCRF determines a QoS set ID or a Differentiated Services Code Point (DSCP) value to be used for each QoS parameter set included in each connection and incorporates the same into a Path-Registration-Response (Path-Reg-Rsp) message, and then transfers the same to a base station.

The base station stores a QoS set Identifier (ID) or a DSCP value allocated for each QoS parameter set. In addition, the base station informs an ASN GW that a relevant QoS parameter set is used by incorporating a relevant QoS ID or a DSCP value into a header of a Generic Route Encapsulation (GRE) packet and transmitting the same when transferring a data packet corresponding to a currently activated QoS parameter set from the base station via a GRE tunnel to the ASN GW.

In the case where a PCRF is used, the ASN GW determines whether a QoS ID or a DSCP value corresponding to the activated QoS parameter set is normally used, and when an error exists, informs the PCRF of the error to perform an additional operation.

Next, a procedure for changing an activated QoS parameter set proposed by an exemplary embodiment of the present invention is described.

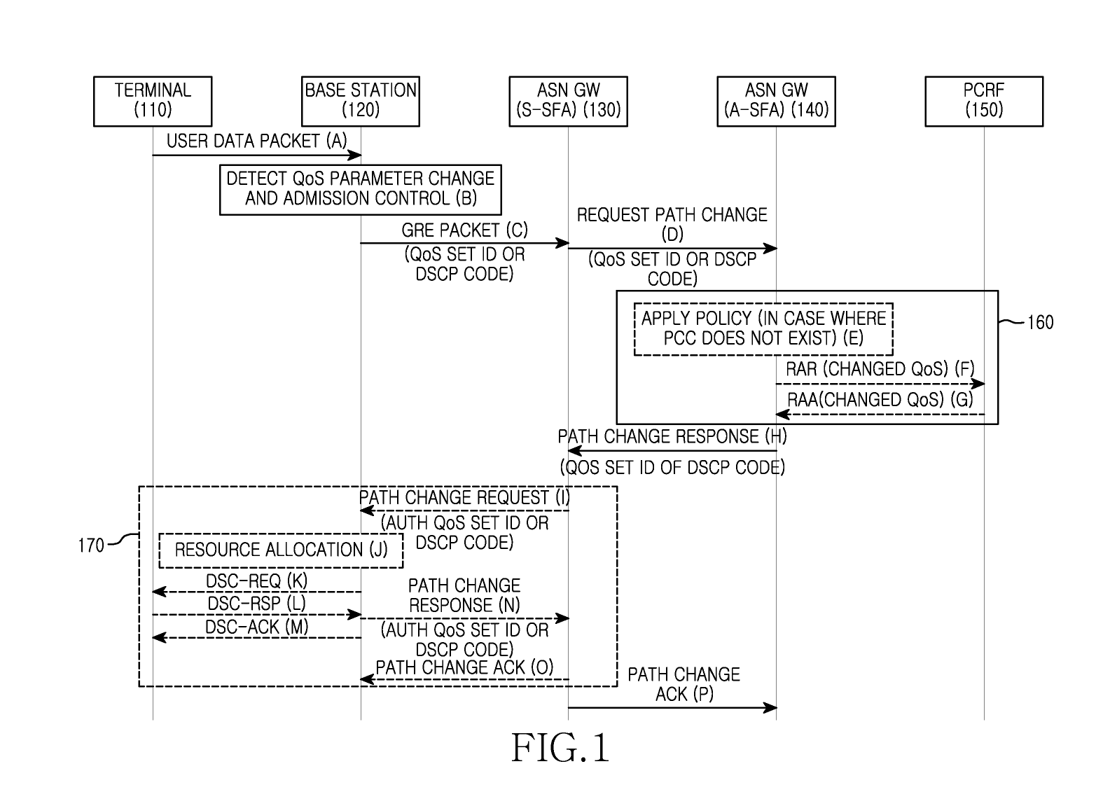

FIG. 1 is a view illustrating a control signal message flow for controlling a data path for transmitting traffic of an aGPS service class according to an exemplary embodiment of the present invention.

Referring to FIG. 1, when a terminal 110 or a network changes a QoS parameter set depending on necessity, in case of an aGPS service class according to an exemplary embodiment of the present invention, the terminal 110 or a base station 120 transmits a scheduled user data packet to a counterpart node using a changed QoS parameter set without a separate signal procedure. Alternatively, the terminal 110 may transmit a control message for changing a QoS to the base station.

FIG. 1 corresponds to a case where the terminal 110 changes a QoS parameter set and transmits a user data packet in step A. Since a case where a network changes a parameter set is described as a similar process, description thereof is omitted for conciseness. An exemplary embodiment of the present invention is described using a case where the terminal 110 starts to change a QoS parameter.

The base station 120 that receives a user data packet tries QoS filtering (or regulation) using a currently set (activated) QoS parameter set. At this point, when detecting that the currently set QoS parameter is unavailable due to a QoS parameter change, the base station 120 estimates the changed QoS parameter set by sequentially using different QoS parameter sets additionally in step B.

When detecting the change of the QoS parameter set, the base station 120 informs an ASN GW 130 that the activated QoS parameter set of the terminal 110 has changed by replacing a QoS set ID or a DSCP code value included in a GRE packet header transferred via the GRE tunnel with a QoS set ID or a DSCP code value allocated to a relevant changed QoS parameter set, and transferring the same to the ASN GW 130 in step C.

In the case where the ASN GW 130 responsible for a Data Plane (DP) and an ASN GW 140 responsible for a Control Plane (CP) are separated, a signaling procedure may be used in which the anchor ASN GW 130 responsible for the DP receives a GRE data packet where a QoS set ID or a DSCP code value has changed from the base station 120, and transmits an R4 Path-Registration-Request (Path-Reg-Req) message requesting a path change by a QoS parameter change to transfer the same to the Auth ASN GW 140 responsible for the CP in step D. After that, a determination is made of whether to allow the changed QoS parameter set in step 160.

In the case where the ASN GW is responsible for both the DP and CP, the inside of the ASN GW performs the above procedure.

When a PCC does not exist, the ASN GW 140 may determine whether to allow the changed QoS parameter set based on a stored user QoS policy in step E, and transfer, in step I, a result thereof to the base station 120 via the ASN GW 130 to which the result was transferred in step H.

On the other hand, when the PCC exists, a PCRF 150 determines whether to allow the changed QoS parameter set via relevant signaling in step F based on a stored user QoS policy, and transfers a result thereof to the base station 120 via the ASN GW 140 and 130 in steps G, H, I.

During this process, in the case where a QoS parameter set changed by the terminal 110 is not allowable according to a user QoS policy, the ASN GW 140 or the PCRF 150 performs the following process in step 170.

That is, the ASN GW 140 or the PCRF 150 instructs step I the base station 120 to perform DSC procedures of steps K, L, and M for QoS change, thereby allowing the terminal 110 to change to a QoS parameter set allowed to a user. Here, the base station 120 allocates a resource to the terminal 110 in step J.

The ASN GW 130 detects that all processes for the above process have been completed from the base station 120 in step N), and informs the base station 120 and the ASN GW 140 of a response for the detection in steps O and P. After that, the activated QoS parameter set is used.

In the case where the changed QoS parameter set of the terminal 120 is approved by the ASN GW 140 or the PCRF 150, a relevant QoS parameter set may be activated and used without a separate process. Alternatively, the ASN GW 140 or the PCRF 150 may approve use of the changed QoS parameter set, and transmit a result thereof to the base station 120 and the terminal 130 via the ASN GW 130.

According to an exemplary embodiment of the present invention, when detecting a change of a QoS parameter set in a DP, a base station may complete a required procedure by only changing a QoS set ID or a DSCP code value of a GRE header. When a changed QoS set ID or DSCP code value is received, the ASN GW may perform a required procedure by triggering a predetermined signal procedure within a CP internally.

Instead of using a complicated process of monitoring a QoS change and generating a signal procedure of a CP via a signal inside of a base station when supporting an aGPS service class, according to exemplary embodiments of the present invention, a DP may detect a QoS change and report the same to an ASN GW via a general data packet transferred via a GRE tunnel In that case, an error occurrence probability that may occur during a complicated signal processing procedure may be reduced and a more efficient process may be achieved.

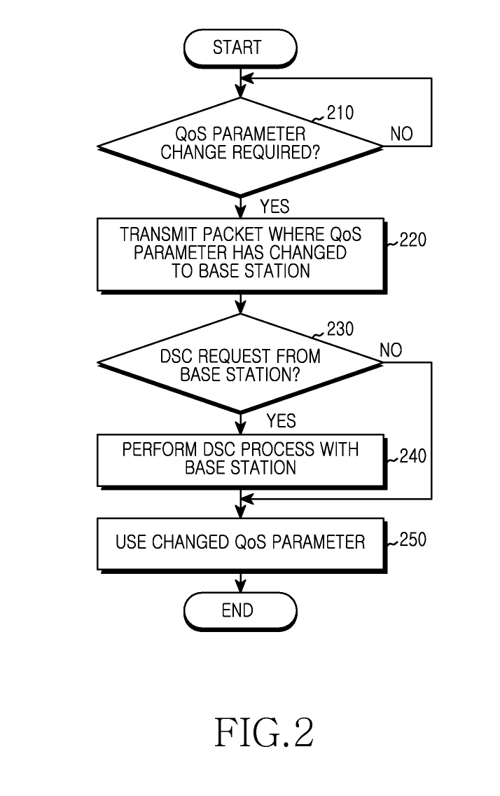

FIG. 2 is a flowchart illustrating a process for operating a terminal according to an exemplary embodiment of the present invention.

Referring to FIG. 2, when a QoS parameter change is required in step 210, the terminal transmits a user data packet where QoS has changed to a base station in step 220. A case where a QoS parameter change is required may be generated due to various causes such as a user's request, a network environment, etc.

When it is determined in step 230 that a DSC request is received from a base station, the terminal performs a DSC process for changing a QoS parameter with the base station in step 240. The terminal uses the changed QoS parameter in step 250.

On the other hand, when it is determined in step 230 that the DSC request is not received from the base station, the terminal may use a QoS parameter changed in a previous step (e.g., step 220) in step 250.

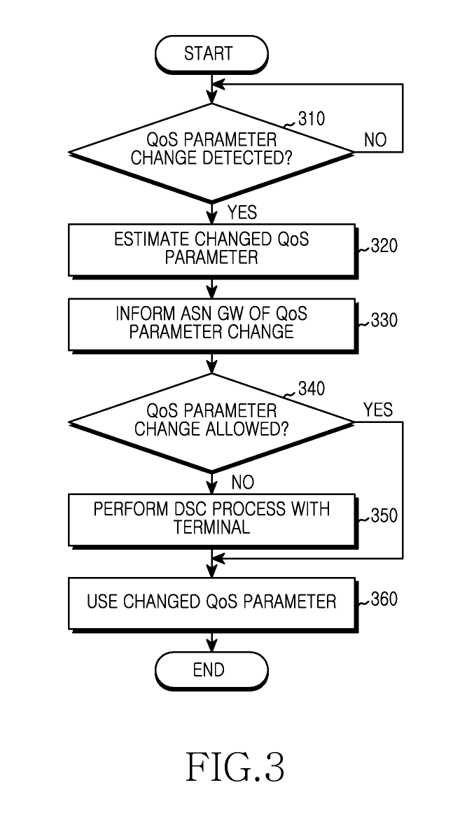

FIG. 3 is a flowchart illustrating a process for operating a base station according to an exemplary embodiment of the present invention.

Referring to FIG. 3, when analyzing a user data packet transmitted by a terminal and detecting a QoS parameter change in step 310, the base station estimates which is the changed QoS parameter in step 320.

The base station informs an ASN GW of the QoS parameter change in step 330. At this point, the base station incorporates a data packet including a QoS ID or a DSCP value corresponding to a QoS parameter set that the base station desires to change currently into a header of a GRE packet and transfers the same to the ASN GW via a GRE tunnel.

When it is determined in step 340 that a QoS parameter change is allowed by the ASN GW, the base station uses the changed QoS parameter in step 360.

When it is determined that in step 340 that the QoS parameter change is not allowed by the ASN GW, that is, when performance of a DSC process with a terminal is required in order to use the QoS change, the base station performs the DSC process with the terminal in step 350, and uses the changed QoS parameter in step 360.

The base station determines whether to perform the DSC via an instruction from the ASN GW or the PCRF. When not receiving a DSC performance instruction, the base station may determine to use a changed QoS parameter even without a separate changed QoS parameter use instruction. Alternatively, when receiving a response informing of a QoS parameter change allowance, the base station may determine use of the changed QoS parameter.

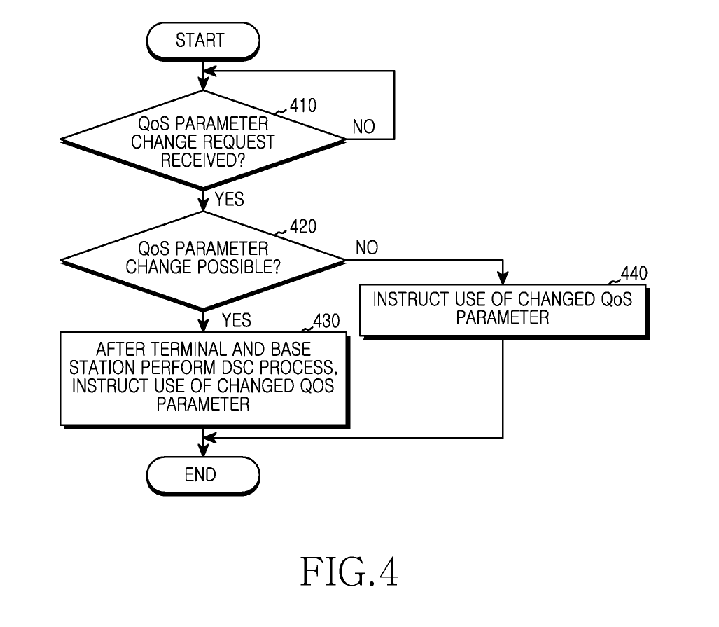

FIG. 4 is a flowchart illustrating a process for operating an ASN GW or a PCRF according to an exemplary embodiment of the present invention.

Referring to FIG. 4, the ASN GW is a network entity that can determine a QoS parameter change allowance.

When it is determined in step 410 that a QoS parameter change request for a terminal transmitted by a base station is received, the ASN GW or the PCRF determines whether the QoS parameter change is allowable based on stored information.

When it is determined in step 420 that the QoS parameter change is not allowable0, the PCRF instructs the base station via the ASN GW to use the changed QoS parameter after the terminal and the base station perform a DSC process in step 430. The ASN GW instructs the base station to use the changed QoS parameter after the terminal and the base station perform the DSC process.

On the other hand, when it is determined in step 420 that the QoS parameter change is allowable, the PCRF transmits the changed QoS parameter use instruction to the base station via the ASN GW in step 440. The ASN GW transmits the changed QoS parameter use instruction to the base station. The QoS parameter use instruction may not be transmitted depending on realization.

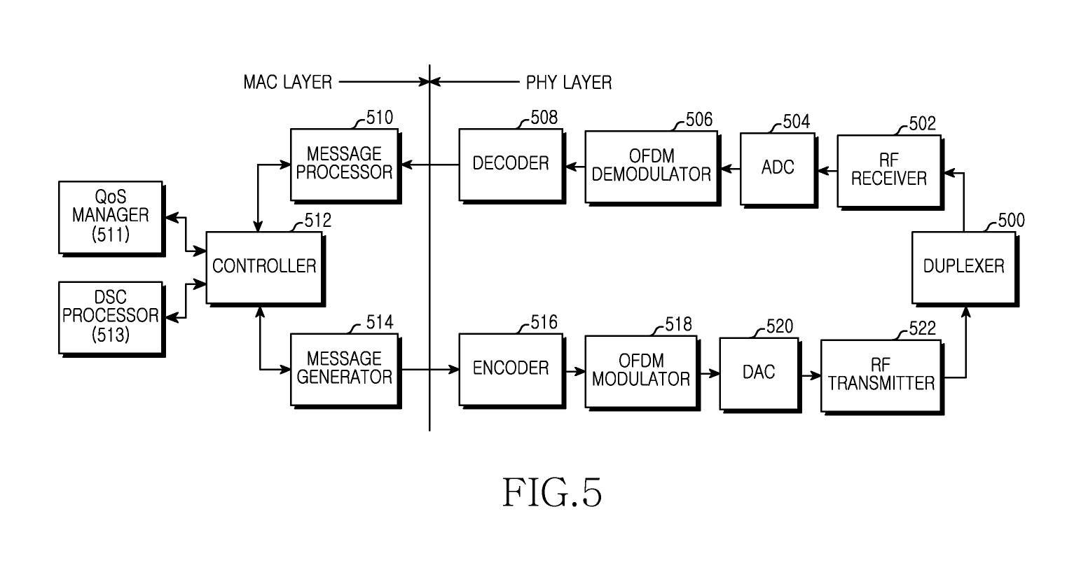

FIG. 5 is a block diagram illustrating a terminal or a base station according to an exemplary embodiment of the present invention.

Referring to FIG. 5, as illustrated, the terminal and the base station according to an exemplary embodiment of the present invention include a duplexer 500, a Radio Frequency (RF) receiver 502, an Analog to Digital Converter (ADC) 504, an Orthogonal Frequency Division Multiplexing (OFDM) demodulator 506, a decoder 508, a message processor 510, a QoS manager 511, a controller 512, a DSC processor 513, a message generator 514, an encoder 516, an OFDM modulator 518, a Digital to Analog Converter (DAC) 520, and an RF transmitter 522.

The duplexer 500 transfers a reception signal from an antenna to the RF receiver 502 and transmits a transmission signal from the RF transmitter 522 via the antenna according to a duplexing scheme.

The RF receiver 502 converts an RF signal from the duplexer 500 into a baseband analog signal. The ADC 504 converts an analog signal from the RF receiver 502 into sample data and outputs the same. The OFDM demodulator 506 converts sample data output from the ADC 504 into data in a frequency domain by performing Fast Fourier Transform (FFT).

The decoder 508 selects data of subcarriers to be received from data in the frequency domain from the OFDM demodulator 506, and demodulates and decodes the selected data according to a predetermined Modulation and Coding Scheme (MCS) level.

The message processor 510 detects a packet on a predetermined basis from data from the decoder 508, and performs a header and error test on the detected packet. At this point, when determining a QoS parameter through the header test, the message processor 510 provides a QoS parameter to the controller 512. That is, the message processor 510 extracts a QoS parameter from a received message and transfers the same to the controller 512.

The controller 512 performs a relevant process based on information from the message processor 510. In addition, when information transmission is required, the controller 512 generates relevant information and provides the same to the message generator 514. The message generator 514 generates a message using various information provided from the controller 512 and outputs the same to the encoder 516 of a physical layer.

The encoder 516 encodes and modulates data from the message generator 514 according to a predetermined MCS level. The OFDM modulator 518 outputs sample data by performing Inverse Fast Fourier Transform (IFFT) on data from the encoder 516. The DAC 520 converts the sample data into an analog signal. The RF processor 522 converts an analog signal from the DAC 520 into an RF signal and transmits the same via the antenna.

In the above construction, the controller 512 serves as a protocol controller. The controller 512 controls the message generator 514, the QoS manager 511, and the DSC processor 513, and controls an overall operation of the base station and the terminal. That is, the controller 512 may perform the functions of the message processor 510, the message generator 514, the QoS manager 511, and the DSC processor 513.

Separate configuration of the message processor 510, the message generator 514, the QoS manager 511, and the DSC processor 513 in an exemplary embodiment of the present invention is for separately describing each function. However, in actual realization, all or some of the functions of the message processor 510, the message generator 514, the QoS manager 511, and the DSC processor 513 may be processed by the controller 512. In addition, the functional blocks corresponding to the physical layer (PHY layer) in the drawing may be denoted by a modem.

Hereinafter, an operation of the terminal is described with reference to the construction of FIG. 5.

First, the terminal is described. When a QoS parameter change is required, the QoS manager 511 provides a user data packet where QoS has changed to the message generator 514 via the controller 512. A case where a QoS parameter change is required may be generated due to various causes such as a user's request, a network environment, etc.

When receiving a DSC request from a base station, the DSC processor 513 controls the modem to perform a DSC process for changing a QoS parameter with the base station.

After that, the QoS manager 511 uses the changed QoS parameter. Even when not receiving the DSC request from the base station, the DSC processor 513 controls the modem to use the changed QoS parameter.

Hereinafter, an operation of the base station is described with reference to the construction of FIG. 5.

The operation of the base station is described. When analyzing a user data packet transmitted by a terminal and detecting a QoS parameter change, the QoS manager 511 estimates which is the changed QoS parameter. After that, the QoS manager 511 informs the ASN GW of the QoS parameter change via a modem. At this point, the QoS manager 511 incorporates a data packet including a QoS ID or a DSCP value corresponding to a currently activated QoS parameter set into a header of a GRE packet and transfers the same to the ASN GW via the modem by way of a GRE tunnel When the QoS parameter change is allowed by the ASN GW, the QoS manager 511 controls the modem to use the changed QoS parameter.

When the QoS parameter change is not allowed by the ASN GW, that is, when performance of a DSC procedure with a terminal is required in order to use the changed QoS, the DSC processor 513 controls the modem to perform the DSC procedure with the terminal (e.g., step 350 of FIG. 3) and uses the changed QoS parameter.

The DSC processor 513 determines whether to perform the DSC via an instruction from the ASN GW or the PCRF. When the DSC processor 513 does not receive a DSC performance instruction, the QoS manager 511 may determine a use of the changed QoS parameter even without a separate instruction of using the changed QoS parameter.

The above-described modem is for communication with the terminal and may be called a wireless modem. In addition, the controller 512, though not shown, includes a wired modem for communicating with an upper node, of course.

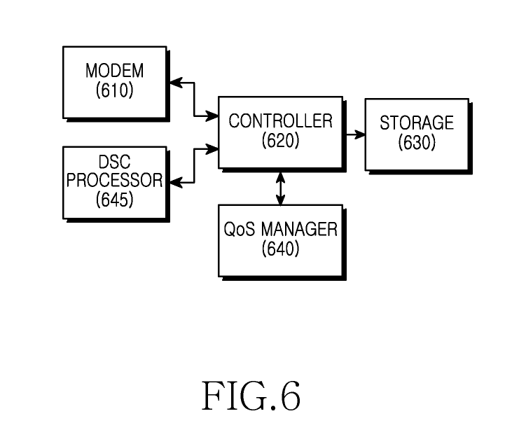

FIG. 6 is a block diagram illustrating an ASN GW or a PCRF according to an exemplary embodiment of the present invention.

Referring to FIG. 6, the ASN GW or the PCRF includes a modem 610, a controller 620, a storage 630, a QoS manager 640, and a DSC processor 645.

The modem 610 serves as a module for communicating with a different apparatus and includes a wired processor and a baseband processor. The wired processor converts a signal received via a wired path into a baseband signal and provides the same to the baseband processor, converts a baseband signal from the baseband processor into a wired signal so that the signal may be transmitted on the wired path, and transmits the signal via the wired path.

The controller 620 controls an overall operation of the ASN GW or the PCRF. More particularly, according to an exemplary embodiment of the present invention, the controller 620 controls the QoS manager 640.

The storage 630 stores programs regarding an overall operation of the ASN GW or the PCRF and temporary data occurring during execution of programs.

When receiving a QoS parameter change request for a terminal transmitted by a base station, the QoS manager 640 determines whether the QoS parameter change is allowable based on information stored in the storage 630.

When the QoS parameter change is not allowable, after the terminal and the base station perform a DSC procedure, the DSC processor 645 of the PCRF instructs the base station to use the changed QoS parameter via the ASN GW.

When the QoS parameter change is not allowable, after the terminal and the base station perform the DSC procedure, the DSC processor 645 of the ASN GW instructs the base station to use the changed QoS parameter.

When the QoS parameter change is allowable, the QoS manager 640 of the PCRF transmits an instruction of using the changed QoS parameter to the base station via the ASN GW.

When the QoS parameter change is allowable, the QoS manager 640 of the ASN GW transmits an instruction of using the changed QoS parameter to the base station.

Here, regardless of the ASN GW or PCRF, the QoS manager 640 may not transmit any instruction when the QoS parameter change is allowable.

In the above construction, the controller 620 serves as a protocol controller and controls the QoS manager 640. That is, the controller 620 may perform the function of the QoS manager 640.

The configuration of the QoS manager 640 is described separately to clarify each function. However, in actual realization, all or some of the functions of the QoS manager 640 may be processed by the controller 620.

According to exemplary embodiments of the present invention, during an initial connection setting procedure of the aGPS service class, a terminal and a network negotiate a plurality of QoS parameter sets to be used, and then may change to a QoS parameter set and use the same without a separate process of transmitting a control signal when needed.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for changing a Quality of Service (QoS) of a terminal in a mobile communication system, the method comprising:
when it is determined to change the QoS, transmitting a packet where a QoS parameter has been changed to a base station; and
when a Dynamic Service Change (DSC) performance request is not received from the base station, using the changed QoS parameter.

2. The method of claim 1, further comprising:
when a DSC performance request is received from the base station, performing the DSC with the base station; and
using the changed QoS parameter.

3. The method of claim 1, wherein the transmitting of the packet where the QoS parameter has been changed to the base station comprises one of transmitting a scheduled user data packet to the base station using a changed QoS parameter set, and transmitting a control message for changing the QoS to the base station.

4. A method for changing a Quality of Service (QoS) of a base station in a mobile communication system, the method comprising:
when detecting a QoS parameter change from a packet received from a terminal, determining the changed QoS parameter;
transmitting a Generic Route Encapsulation (GRE) packet to which the changed QoS parameter has been applied to an upper node;
when performance of a Dynamic Service Change (DSC) with the terminal is requested by the upper node, performing the DSC with the terminal; and
applying the changed QoS parameter.

5. The method of claim 4, further comprising, when the performance of the DSC with the terminal is not requested by the upper node or no response exists, applying the changed QoS parameter.

6. The method of claim 4, wherein the transmitting of the GRE packet to which the changed QoS parameter has been applied to the upper node comprises:
replacing a QoS set Identifier (ID) or a Differential Services Code Point (DSCP) code value included in a GRE packet header transferred via a GRE tunnel by a QoS set ID or a DSCP code value allocated to a relevant changed QoS parameter; and
transmitting an updated GRE packet to the upper node.

7. A method for changing a Quality of Service (QoS) of a network apparatus in a mobile communication system, the method comprising:
determining whether a Generic Route Encapsulation (GRE) packet where a QoS parameter has been changed is received from a base station;
when receiving the GRE packet where the QoS parameter has been changed, determining whether to allow a QoS parameter change based on a user QoS policy; and
when not allowing the QoS parameter change, requesting the base station to perform Dynamic Service Change (DSC).

8. The method of claim 7, further comprising, when allowing the QoS parameter change, not providing a response to the base station or transmitting a response informing of a QoS parameter change allowance to the base station.

9. The method of claim 7, further comprising:
when receiving the GRE packet where the QoS parameter has been changed, requesting an upper node to allow the QoS parameter change; and
when a response from the upper node does not allow the QoS parameter change, requesting the base station to perform the DSC.

10. The method of claim 9, further comprising, when the response from the upper node allows the QoS parameter change, not providing a response to the base station or transmitting a response informing of a QoS parameter change allowance to the base station.

11. The method of claim 7, wherein the packet where the QoS parameter has been changed comprises a packet where a QoS set Identifier (ID) or a Differential Services Code Point (DSCP) code value included in a GRE packet header is replaced by a QoS set ID or a DSCP code value allocated to a relevant changed QoS parameter.

12. An apparatus of a terminal for changing a Quality of Service (QoS) in a mobile communication system, the apparatus comprising:
a QoS manager for, when it is determined to change the QoS, determining to transmit a packet where a QoS parameter has been changed to a base station, and for, when a Dynamic Service Change (DSC) performance request is not received from the base station, using the changed QoS parameter; and
a modem for transmitting a packet where the QoS parameter has been changed to the base station, and for receiving the DSC performance request from the base station.

13. The apparatus of claim 12, further comprising a DSC processor for performing the DSC with the base station via the modem when the DSC performance request is received from the base station,
wherein the QoS manager uses the changed QoS parameter.

14. The apparatus of claim 12, wherein, when transmitting the packet where the QoS parameter has been changed to the base station, the QoS manager transmits a scheduled user data packet to the base station using a changed QoS parameter set, or transmits a control message for changing a QoS to the base station.

15. An apparatus of a base station for changing a Quality of Service (QoS) in a mobile communication system, the apparatus comprising:
a wireless modem for communicating with a terminal;
a wired modem for communicating with an upper node;
a QoS manager for, when detecting a QoS parameter change from a packet received from the terminal via the wireless modem, determining the changed QoS parameter, for transmitting a Generic Route Encapsulation (GRE) packet to which the changed QoS parameter has been applied to the upper node via the wired modem, and for applying the changed QoS parameter; and
a Dynamic Service Change (DSC) processor for, when performance of a DSC with the terminal is requested by the upper node, determining to perform the DSC with the terminal.

16. The apparatus of claim 15, wherein, when the performance of the DSC with the terminal is not requested by the upper node or no response exists, the QoS manager applies the changed QoS parameter.

17. The apparatus of claim 15, wherein the QoS manager replaces a QoS set Identifier (ID) or a Differential Services Code Point (DSCP) code value included in a GRE packet header transferred via a GRE tunnel by a QoS set ID or a DSCP code value allocated to a relevant changed QoS parameter, and transmits an updated GRE packet to the upper node to transmit the GRE packet to which the changed QoS parameter has been applied to the upper node.

18. A network apparatus for changing a Quality of Service (QoS) in a mobile communication system, the apparatus comprising:
a modem for communicating with a base station; and
a QoS manager for determining whether a Generic Route Encapsulation (GRE) packet where a QoS parameter has been changed is received from the base station via the modem, and for, when receiving the GRE packet where the QoS parameter has been changed, determining whether to allow a QoS parameter change based on a user QoS policy; and
a DSC processor for, when the QoS parameter change is not allowed, requesting the base station to perform Dynamic Service Change (DSC).

19. The apparatus of claim 18, wherein, when allowing the QoS parameter change, the QoS manager does not provide a response to the base station or transmits a response informing of QoS parameter change allowance to the base station.

20. The apparatus of claim 18, wherein, when receiving the GRE packet where the QoS parameter has been changed, the QoS manager requests an upper node to allow QoS parameter change, and when a response from the upper node does not allow the QoS parameter change, the DSC processor requests the base station to perform the DSC.

21. The apparatus of claim 20, wherein, when the response from the upper node allows the QoS parameter change, the QoS manager does not provide a response to the base station or transmits a response informing of QoS parameter change allowance to the base station.

22. The apparatus of claim 18, wherein the packet where the QoS parameter has been changed comprises a packet where a QoS set Identifier (ID) or a Differential Services Code Point (DSCP) code value included in a GRE packet header is replaced by a QoS set ID or a DSCP code value allocated to a relevant changed QoS parameter.

23. A system for changing a Quality of Service (QoS) in a mobile communication system, the system comprising:
a terminal for, when it is determined to change the QoS, transmitting a packet where the QoS parameter has been changed to a base station, and for, when a Dynamic Service Change (DSC) performance request is not received from the base station, using the changed QoS parameter;
the base station for, when detecting a QoS parameter change from a packet received from the terminal, determining the changed QoS parameter, for transmitting a Generic Route Encapsulation (GRE) packet to which the changed QoS parameter has been applied to a network apparatus, and for, when performance of a DSC with the terminal is requested by the network apparatus, performing the DSC with the terminal to apply the changed QoS parameter; and
the network apparatus for determining whether a GRE packet where the QoS parameter has been changed is received from the base station, for, when receiving the GRE packet where the QoS parameter has been changed, determining whether to allow the QoS parameter change based on a user QoS policy, and for, when not allowing the QoS parameter change, requesting the base station to perform the DSC.

24. The system of claim 23, wherein, when the DSC performance request is received from the base station, the terminal performs the DSC with the base station and uses the changed QoS parameter.

25. The system of claim 23, wherein, when the performance of the DSC with the terminal is not requested by the network apparatus or no response exists, the base station applies the changed QoS parameter.

26. The system of claim 23, wherein the base station replaces a QoS set Identifier (ID) or a Differential Services Code Point (DSCP) code value included in a GRE packet header transferred via a GRE tunnel by a QoS set ID or a DSCP code value allocated to a relevant changed QoS parameter, and transmits an updated GRE packet to an upper node to transmit the GRE packet to which the changed QoS parameter has been applied to the upper node.

27. The system of claim 23, wherein, when allowing the QoS parameter change, the network apparatus does not provide a response to the base station or transmits a response informing of QoS parameter change allowance to the base station.

28. The system of claim 23, wherein, when receiving the GRE packet where the QoS parameter has been changed, the network apparatus requests an upper node to allow the QoS parameter change, and
when a response from the upper node does not allow the QoS parameter change, the network apparatus requests the base station to perform the DSC.

29. The system of claim 28, wherein, when the response from the upper node allows the QoS parameter change, the network apparatus does not provide a response to the base station or transmits a response informing of QoS parameter change allowance to the base station.

30. The system of claim 23, wherein, when transmitting the packet where the QoS parameter has been changed to the base station, the terminal transmits a scheduled user data packet to the base station using a changed QoS parameter set, or transmits a control message for changing QoS to the base station.

31. The system of claim 23, wherein the packet where the QoS parameter has been changed comprises a packet where a QoS set ID or a Differential Services Code Point (DSCP) code value included in a GRE packet header is replaced by a QoS set ID or a DSCP code value allocated to a relevant changed QoS parameter.
